(19) United States
(12) Patent Application Publication
(10) Pub. No.: US 2009/0080904 A1
(43) Pub. Date: Mar. 26, 2009

(54) Optical transmitting apparatus and setting-value determining method

(75) Inventor: Kenichi Nakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/219,939

(22) Filed: Jul. 30, 2008

(30) Foreign Application Priority Data
Sep. 25, 2007 (JP) 2007-247351

(51) Int. Cl. H04B 10/04

(52) U.S. Cl. 398/183

(57) ABSTRACT

A wavelength-variable light source generates light having a wavelength according to an input wavelength control current. An EA modulator modulates light generated by the wavelength-variable light source, based on a modulation characteristic corresponding to an input EA bias. A TEC changes the temperature of the wavelength-variable light source and that of the EA modulator according to an input temperature control current. A control unit adjusts the setting-value of the wavelength control current input to the wavelength-variable light source, the setting-value of the EA bias input to the EA modulator, and the setting-value of the temperature of the EA modulator according to input wavelength data.

### CROSS-REFERENCE TO RELATED APPLICATIONS

This application is based upon and claims the benefit of priority from the prior Japanese Patent Application No. 2007-247351, filed on Sep. 25, 2007, the entire contents of which are incorporated herein by reference.

### BACKGROUND OF THE INVENTION

1. Field of the Invention

The present invention relates to an optical transmitting apparatus that controls the wavelength of the light transmitted, and a setting-value determining method for an optical transmitting apparatus.

2. Description of the Related Art

With the increase in data traffic, long-distance, high-speed, high-capacity communication has become essential and the establishment of wavelength division multiplexing (WDM) networks has progressed. WDM requires optical transmitting apparatuses that transmit a variety of light having different wavelengths, thereby complicating the management of stocks and types of optical transmitting apparatuses. An optical transmitting apparatus using a wavelength-variable light source capable of varying an output wavelength, therefore, is a key device in effectively simplifying production control through a reduction in stocks and types of optical transmitting apparatuses.

In an effort to provide an optical transmission system having a smaller size and a larger capacity, expectation is high on the realization of a small-sized transmitter optical subassembly (TOSA) of a XFP (10 Gigabit Small Form Factor Pluggable) type. To realize the XFP type TOSA, two major problems must be addressed. One problem is (1) the integration of a wavelength-variable light source and an electric absorption (EA) modulator, and the other problem is (2) a reduction in circuit scale and power consumption through simplification of wavelength control.

A wavelength-variable light source of a temperature-variable type or external resonator type is not suitable to resolve problems (1) or (2). However, a current-injection type wavelength-variable light source can be easily integrated with an EA modulator, thus enabling simple wavelength control and reduced power consumption. An optical transmitting apparatus having a current-injection type wavelength-variable light source and an EA modulator in an integrated configuration, therefore, is preferable as an optical transmitting apparatus applicable to a small-sized XFP type TOSA.

A wavelength-variable light source and an EA modulator are integrated on a thermoelectric cooler (TEC), and are put under temperature control corresponding to a temperature control current input to the TEC. In an optical transmitting apparatus having a current-injection type wavelength-variable light source and an EA modulator in an integrated configuration, chirping (α-parameter) at the EA modulator shows great wavelength dependency, thus posing a problem of not being able to provide light having satisfactory transmission characteristics at the time of wavelength control. To solve this problem, for a temperature-variable type wavelength-variable light source, conventional control methods for providing light having satisfactory transmission characteristics at the time of varying a wavelength have been suggested, such as those disclosed in Japanese Patent Application Laid-Open Publication Nos. 2001-144367, 2001-154162, 2005-45548, 2002-323685, and H9-179079.

However, for the above optical transmitting apparatus having the current-injection type wavelength-variable light source and the EA modulator in the integrated configuration, there is no control method at the time of wavelength control for providing light having satisfactory transmission characteristics and the optical transmitting apparatus has a problem in that varying wavelength results in deteriorated transmission characteristics. Concerning this problem, for example, controlling the EA bandgap wavelength variation of the EA modulator by adjusting an EA bias input to the EA modulator at the time of wavelength control through current injection may be one solution. This solution, however, raises the following problem.

FIG. 19 is a graph concerning wavelength control and control of variation of an EA bandgap wavelength. In FIG. 19, the horizontal axis represents the temperature of an EA modulator (hereinafter, “EA temperature”), and the vertical axis represents wavelength. Here, description is made of wavelength control that varies the wavelength of light output from an optical transmitting apparatus (hereinafter “output wavelength”) from an initial state of λ1 to λ4. The value of a temperature control current input to a TEC is adjusted to a constant setting-value, independent of wavelength.

A line 1910 indicates the variation of an output wavelength with respect to EA temperature when the value of a wavelength control current has been adjusted to a setting-value corresponding to the wavelength λ1. A point 1911 indicates an output wavelength that results on the line 1910 when the EA temperature is 45° C. A line 1920 indicates the variation of an EA bandgap wavelength with respect to the EA temperature when the value of an EA bias has been adjusted to a setting-value corresponding to the wavelength λ1.

First, by adjusting the value of the wavelength control current to a setting-value corresponding to the wavelength λ4, as denoted by reference numeral 1901, the output wavelength is controlled to become the wavelength λ4 (point 1940). Then, by adjusting the value of the EA bias to a setting-value corresponding to the wavelength λ4, as denoted by reference numeral 1902, variation of the EA bandgap wavelength is controlled to become as indicated by a line 1950. As a result, a wavelength shift between the output wavelength and the EA bandgap wavelength before and after wavelength control (reference numerals 1930 and 1960) become substantially equivalent.

FIG. 20 is a graph concerning deterioration of light transmitted under the control method shown in FIG. 19. In FIG. 20, the horizontal axis represents the wavelength (nm) of light transmitted from the optical transmitting apparatus, and the vertical axis represents the minimum reception sensitivity (dBm) of the light. Reference numerals 2010 and 2020 indicate the minimum reception sensitivities of the light when the output wavelength is varied from λ1 to λ4 through the wavelength control shown in FIG. 19.

Reference numeral 2010 indicates the minimum reception sensitivity of the light (with no wavelength dispersion) immediately after transmission from the optical transmitting apparatus (B to B). Reference numeral 2020 indicates the minimum reception sensitivity of the light transmitted after passing through a transmission path (approximately 80 km) in which a wavelength dispersion of 1600 ps/nm occurs. When the EA bandgap wavelength variation is controlled at the time of wavelength control through current injection, a voltage range for the EA bias becomes insufficient and the extinction ratio and waveform of the light deteriorate.

As a result, as shown by reference numerals 2010 and 2020, the minimum reception sensitivity of light transmitted from the optical transmitting apparatus deteriorates by 1 dB or more at the time of wavelength control through current injection. Reference numeral 2030 indicates a transmission penalty of the light transmitted from the optical transmitting apparatus when the output wavelength is varied from λ1 to λ4 through the wavelength control method shown in FIG. 19.

As described above, when the EA bandgap wavelength variation is controlled at the time of varying the wavelength through current injection, the minimum reception sensitivity deteriorates making it impossible for the optical transmitting apparatus to provide light having satisfactory transmission characteristics, which is a problem. At the time of wavelength control through current injection, the EA temperature may be controlled by adjusting the temperature control current input to the TEC. This method, however, poses the following problem.

FIG. 21 is a graph concerning wavelength control and EA temperature control. In FIG. 21, the horizontal axis represents the EA temperature, and the vertical axis represents the wavelength. Here, description is made of control that varies the output wavelength from an initial state of λ1 to λ4. The value of the EA bias input to the EA modulator is adjusted to a constant setting-value independent of wavelength.

A line 2110 indicates the variation of an output wavelength with respect to the EA temperature when the value of the wavelength control current has been adjusted to a setting-value corresponding to the wavelength λ1. A point 2111 indicates an output wavelength that results on the line 2110 when the EA temperature is 45° C. A line 2120 indicates the variation of an EA bandgap wavelength with respect to the EA temperature when the value of the EA bias has been adjusted to a setting-value corresponding to the wavelength λ1.

First, by adjusting the value of the temperature control current to a setting-value corresponding to the wavelength λ4, as denoted by reference numeral 2101, the EA temperature is controlled to become 39° C. (point 2112). Then, by adjusting the value of the wavelength control current to a setting-value corresponding to the wavelength λ4, as denoted by reference numeral 2102, the output wavelength is controlled to become the wavelength λ4 (point 2140).

Because the EA bandgap wavelength varies in correspondence to a variation in the EA temperature, a wavelength shift between the output wavelength and the EA bandgap wavelength before and after wavelength control (reference numerals 2130 and 2150) are made substantially equivalent by properly determining the setting-value of the temperature control current. Therefore, to change the output wavelength greatly, control to also change the EA temperature greatly is necessary.

FIG. 22 is a graph of a FIT number and power consumption for the control method shown in FIG. 21. In FIG. 22, the horizontal axis represents the EA temperature (° C.). A function 2211 indicates the relation between the FIT number and the EA temperature of the optical transmitting apparatus. The FIT number of the optical transmitting apparatus is equivalent to a reliability parameter for evaluating the reliability of the optical transmitting apparatus as a light source. The function 2211 indicates that the FIT number of the optical transmitting apparatus increases as the EA temperature increases. The allowable upper limit for FIT numbers is determined to be 5700.

A threshold 2221 indicates the value of the EA temperature (45° C.) at which the FIT number becomes 5700. A function 2212 indicates the relation between power consumption of the optical transmitting apparatus and the EA temperature. The function 2212 indicates that the power consumption by the optical transmitting apparatus increases as the EA temperature decreases. A temperature range 2230 is the range of EA temperature control that is carried out with wavelength control in the control method of FIG. 21.

When the EA temperature is controlled at the time of varying the wavelength through current injection, the EA temperature control range 2230 must be secured having a wide range so as to equalize wavelength shifts before and after wavelength control. A threshold 2222 indicates the lower limit of the EA temperature control range 2230. In this case, power consumption comes to 1.6 W, which exceeds the upper limit of power consumption (e.g., 1.4 W) that is required when the optical transmitting apparatus is applied to a TOSA.

As described above, when the EA temperature is controlled at the time of varying the wavelength in the optical transmitting apparatus having the current-injection type wavelength-variable light source and the EA modulator in an integrated configuration, power consumption by the optical transmitting apparatus increases. As a result, the optical transmitting apparatus cannot satisfy power consumption and reliability requirements for application to a TOSA, thereby making application of the optical transmitting apparatus in the TOSA difficult.

### SUMMARY OF THE INVENTION

It is an object of the present invention to at least solve the above problems in the conventional technologies.

An optical transmitting apparatus according to one aspect of the present invention includes a light source that generates light having a wavelength according to a wavelength control current input to the light source; a modulator that modulates the light based on a modulation characteristic corresponding to an EA bias input to the modulator; a temperature adjusting unit that changes an EA temperature of the modulator according to a temperature control current input to the temperature adjusting unit; and a control unit that controls the wavelength of the light and the modulation characteristic by adjusting a value of the wavelength control current and a value of the EA bias according to input wavelength data.

An optical transmitting apparatus according to another aspect of the present invention includes a light source that generates light having a wavelength according to a wavelength control current input to the light source; a modulator that modulates the light based on a modulation characteristic corresponding to an EA bias input to the modulator; a temperature adjusting unit that changes an EA temperature of the modulator according to a temperature control current input to the temperature adjusting unit; and a control unit that controls the EA temperature and the wavelength of the light by adjusting a value of the EA temperature controlled by adjustment of the temperature control current and a value of the wavelength control current according to a wavelength indicated by input wavelength data.

A setting-value determining method of an optical transmitting apparatus and according to still another aspect of the present invention includes determining a setting-value of an EA temperature corresponding to a working wavelength, based on data concerning a reliability parameter and power consumption of an optical transmitting apparatus; determining a setting-value of a wavelength control current corresponding to the working wavelength, based on the setting-value of the EA temperature; and determining a setting-value of an EA bias corresponding to the working wavelength, based on the setting-value of a temperature control current and the setting-value of the wavelength control current.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a functional configuration of an optical transmitting apparatus according to a first embodiment;

FIG. 2 depicts a first example of data stored on a memory;

FIG. 3 is a graph of the relation between FIT number, power consumption, and EA temperature;

FIG. 4 is a block diagram of a modification example of the functional configuration of the optical transmitting apparatus;

FIG. 5 is a flowchart of an example of a procedure of determining each setting-value;

FIG. 6 is a graph concerning wavelength control, control of the EA temperature and the EA bandgap wavelength variation;

FIG. 7 is a flowchart of an example of control by the control unit;

FIG. 8 is a flowchart of another example of control by the control unit;

FIG. 9 depicts a second example of data stored on the memory;

FIG. 10 depicts a third example of data stored on the memory;

FIG. 11 is a block diagram of a functional configuration of an optical transmitting apparatus according to a second embodiment;

FIG. 12 depicts a fourth example of data stored on the memory;

FIG. 13 is a block diagram of a modification example of the functional configuration of the optical transmitting apparatus;

FIG. 14 is a flowchart of another example of a procedure of determining each setting-value;

FIG. 15 is a graph of the relation between the FIT number, power consumption, and the EA temperature;

FIG. 16 is a graph of the relation between minimum reception sensitivity and output wavelength;

FIG. 17 is a graph of the relation between transmission penalty and the output wavelength;

FIG. 18 is a front sectional view of an application example of the optical transmitting apparatus to a TOSA;

FIG. 19 is a graph concerning wavelength control and control of variation of an EA bandgap wavelength;

FIG. 20 is a graph concerning deterioration of light transmitted under the control method shown in FIG. 19;

FIG. 21 is a graph concerning wavelength control and EA temperature control; and

FIG. 22 is a graph of FIT number and power consumption for the control method shown in FIG. 21.

### DETAILED DESCRIPTION OF THE PREFERRED EMBODIMENTS

Referring to the accompanying drawings, exemplary embodiments according to the present invention are explained in detail below.

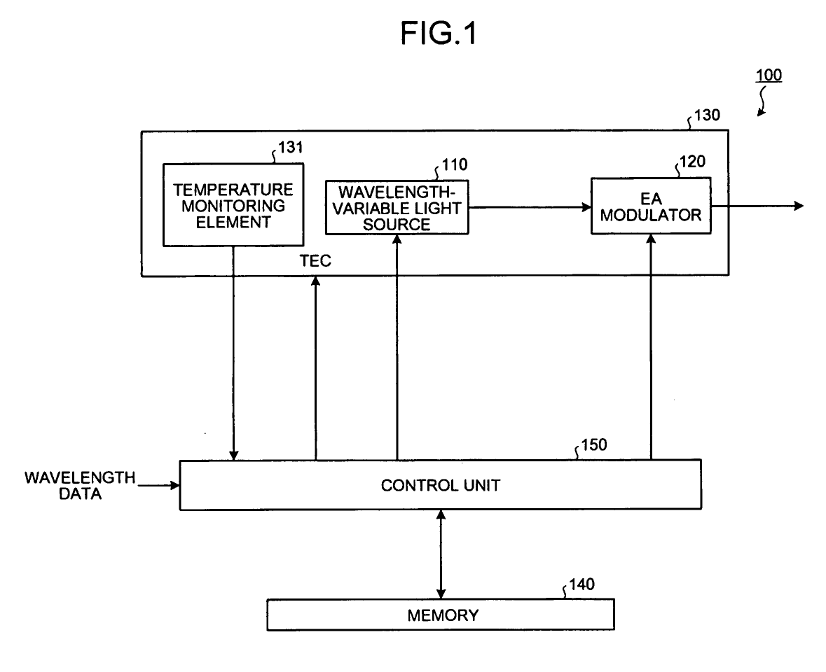

FIG. 1 is a block diagram of a functional configuration of an optical transmitting apparatus according to the first embodiment. The optical transmitting apparatus according to the first embodiment is one that generates light of a variable wavelength and that modulates and transmits the light generated. As shown in FIG. 1, an optical transmitting apparatus 100 according to the first embodiment includes a wavelength-variable light source 110, an EA modulator 120, a TEC 130, a control unit 150, and a memory 140.

The wavelength-variable light source 110 and the EA modulator 120 are mounted on the TEC 130 in an integrated configuration. In addition to a drive current (not shown) for light generation, a wavelength control current output from the control unit 150 is input to the wavelength-variable light source 110. The wavelength-variable light source 110 is a current-injection type wavelength-variable light source that generates light having a wavelength corresponding to the input wavelength control current. The wavelength-variable light source 110 outputs generated light to the EA modulator 120.

Light output from the wavelength-variable light source 110 and an EA bias output from the control unit 150 are input to the EA modulator 120, which modulates the light, based on a modulation characteristic (α-parameter) corresponding to the input EA bias. Specifically, the EA modulator 120 changes an EA bandgap wavelength in correspondence to the input EA bias. The EA modulator 120 outputs modulated light to an external unit.

A temperature control current output from the control unit 150 is input to the TEC 130, which is a temperature adjusting unit that changes the temperature of the wavelength-variable light source 110 and the EA modulator 120 in correspondence to the input temperature control current. Specifically, the temperature of the TEC 130 changes in correspondence to the input temperature control current. As a result, the temperature of the wavelength-variable light source 110 and the EA modulator 120 changes correspondingly to the temperature change of the TEC 130.

A temperature monitoring element 131 is disposed on the TEC 130. The temperature monitoring element 131 outputs EA temperature data indicating the temperature of the EA modulator 120 to the control unit 150. Specifically, the temperature monitoring element 131 is a heat-sensing element that senses the temperature of the TEC 130 and outputs a current corresponding to the temperature of the TEC 130 to the control unit 150 as the EA temperature data.

The memory 140 stores data concerning combinations of respective setting-values for the wavelength control current, the EA bias, and the temperature control current, the data corresponding to preset wavelengths, respectively. Alternatively, the memory 140 may preliminarily store a function of the wavelength control current with respect to wavelength, a function of the EA temperature with respect to wavelength, and a function of the EA bias with respect to wavelength.

The control unit 150 inputs the wavelength control current to the wavelength-variable light source 110. The control unit 150 adjusts the value of the wavelength control current input to the wavelength-variable light source 110 to change the wavelength of light generated from the wavelength-variable light source 110. In this manner, the control unit 150 controls the wavelength of light (output wavelength) transmitted from the optical transmitting apparatus 100.

The control unit 150 inputs the EA bias to the EA modulator 120. The control unit 150 adjusts the value of the EA bias input to the EA modulator 120 to control the variation of the EA bandgap wavelength of the EA modulator 120. In this manner, the control unit 150 controls the transmission characteristic of light transmitted from the optical transmitting apparatus 100.

The control unit 150 inputs the temperature control current to the TEC 130. The control unit 150 controls the temperature of the TEC 130 by adjusting the temperature control current input to the TEC 130 such that a temperature indicated by the EA temperature data output from the temperature monitoring element 131 becomes a target temperature. In this manner, the control unit 150 controls the temperature (EA temperature) of the EA modulator 120.

Wavelength data indicating the wavelength of light to be transmitted by the optical transmitting apparatus 100 is input from an external source to the control unit 150. The wavelength data is, for example, data indicating requirements, such as an output wavelength from the optical transmitting apparatus 100 being adjusted to λ1. The control unit 150 adjusts the combination of the setting-values for the wavelength control current input to the wavelength-variable light source 110, the EA bias input to the EA modulator 120, and the temperature control current input to the TEC 130 corresponding to the wavelength indicated by the wavelength data input to the control unit 150.

Specifically, the control unit 150 reads out a piece of combination data corresponding to a wavelength indicated by the input wavelength data, from the combination data stored on the memory 140. Based on the combination data read out from the memory 140, the control unit 150 adjusts the values of the wavelength control current input to the wavelength-variable light source 110, the EA bias input to the EA modulator 120, and the temperature control current input to the TEC 130.

Alternatively, the control unit 150 reads out the functions of the wavelength control current with respect to wavelength, the function of the EA temperature with respect to wavelength, and the function of the EA bias with respect to wavelength, respectively stored on the memory 140. Based on the functions read out from the memory 140, the control unit 150 respectively calculates setting-values for the wavelength control current, the EA bias, and the temperature control current corresponding to the wavelength indicated by the wavelength data.

Based on each of the calculated setting-values, the control unit 150 adjusts the values of the wavelength control current input to the wavelength-variable light source 110, the EA bias input to the EA modulator 120, and the temperature control current input to the TEC 130, respectively.

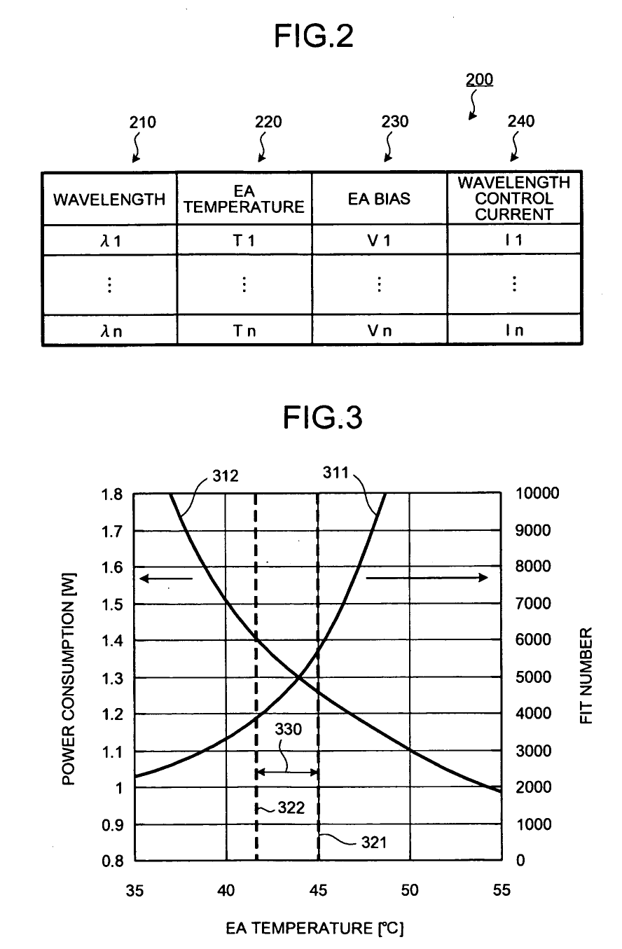

FIG. 2 depicts a first example of data stored on the memory. The memory 140 stores, for example, a table 200 shown in FIG. 2 as data concerning combinations of the respective setting-values for the current input to the wavelength-variable light source 110, the EA bias input to the EA modulator 120, and the temperature control current input to the TEC 130. Reference numeral 210 indicates data concerning wavelengths λ1 to λn corresponding to wavelengths indicated by the wavelength data.

Reference numeral 220 indicates data concerning the setting-values of EA temperatures (T1 to Tn) corresponding to the wavelengths λ1 to λn, respectively. The control unit 150 adjusts the temperature control current input to the TEC 130 such that a temperature indicated by EA temperature data output from the temperature monitor element 131 becomes an EA temperature corresponding to a wavelength (λ1 to λn) indicated by the wavelength data.

Reference numeral 230 indicates data concerning the setting-values of EA biases V1 to Vn corresponding to the wavelengths λ1 to λn, respectively. The control unit 150 inputs, to the EA modulator 120, an EA bias that corresponds to a wavelength indicated by the wavelength data. Reference numeral 240 indicates data concerning the setting-values of wavelength control currents I1 to In corresponding to the wavelengths λ1 to λn, respectively. The control unit 150 inputs, to the wavelength-variable light source 110, a wavelength control current corresponding to a wavelength (λ1 to λn) indicated by the wavelength data.

FIG. 3 is a graph of the relation between the FIT number, power consumption, and the EA temperature. In FIG. 3, the horizontal axis represents the EA temperature (° C.) that is controlled by the control unit 150, and the vertical axes represent the FIT number of the optical transmitting apparatus 100 and power consumption (W) by the apparatus 100. A function 311 indicates the relation between the FIT number and the EA temperature of the optical transmitting apparatus 100.

The FIT number of the optical transmitting apparatus 100 is a reliability parameter for evaluating the reliability of the optical transmitting apparatus 100 as a light source. As indicated by the function 311, the FIT number increases (function deteriorates) as EA temperature increases. The allowable upper limit of the FIT number is determined to be 5700. A threshold 321 indicates the value of the EA temperature (45° C.) at which the FIT number becomes 5700.

A function 312 indicates the relation between the power consumption and the EA temperature of the optical transmitting apparatus 100. As indicated by the function 312, power consumption increases as EA temperature decreases. The allowable upper limit of power consumption is determined to be 1.4 W. A threshold 322 indicates the value of the EA temperature (42° C.) at which the power consumption becomes 1.4 W.

Each setting-value of the EA temperature respectively corresponding to each wavelength used in the optical transmitting apparatus 100 (hereinafter “working wavelength”) is determined within a control range 330 (42° C. to 45° C.). For example, each setting-value of the EA temperature corresponding to each working wavelength is assigned equally within the range of 42° C. to 45° C. In this case, an EA temperature corresponding to a longer wavelength is determined to be a higher temperature.

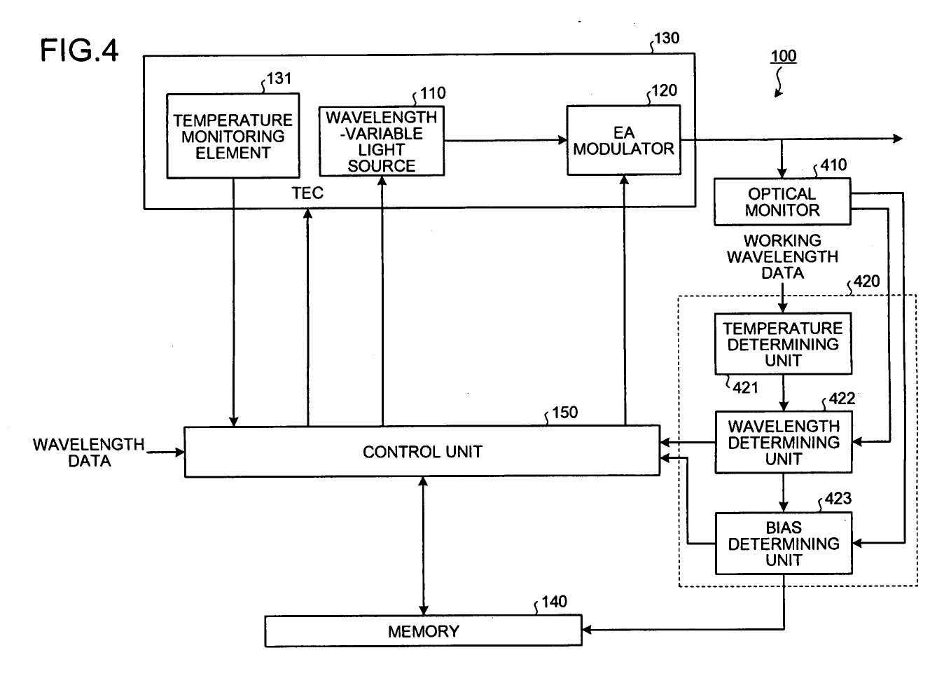

FIG. 4 is a block diagram of an example of modification of the functional configuration of the optical transmitting apparatus. In FIG. 4, similar constituent elements shown in FIG. 1 are denoted by similar reference numerals and description thereof is omitted. As shown in FIG. 4, the optical transmitting apparatus 100 of the first embodiment may include an optical monitor 410, and a setting-value determining unit 420, in addition to the constituent elements shown in FIG. 1.

The optical monitor 410 obtains part of the light output from the EA modulator 120, and monitors the wavelength (output wavelength) and a transmission characteristic of obtained light. The transmission characteristic monitored by the optical monitor 410 is, for example, the extinction ratio of the light. The optical monitor 410 outputs data concerning the monitored wavelength to a wavelength determining unit 422, and also outputs data concerning the monitored transmission characteristic to a bias determining unit 423.

The setting-value determining unit 420 determines data concerning combinations of each setting-value to be stored on the memory 140 by determining the respective setting-values in the order of the temperature control current, the wavelength control current, and the EA bias, respectively, for each of working wavelengths (λ1 to λn). Specifically, the setting-value determining unit 420 has a temperature determining unit 421, the wavelength determining unit 422, and the bias determining unit 423.

Working wavelength data indicating working wavelengths (λ1 to λn) of the optical transmitting apparatus 100 is input to the temperature determining unit 421, which determines each setting-value of the temperature control current corresponding to each working wavelength. Specifically, the temperature determining unit 421 obtains data concerning the functions 311 and 312 (see FIG. 3), and determines each setting-value of the temperature control current based on the reliability parameter of the optical transmitting apparatus 100 and power consumption by the apparatus 100.

For example, the data concerning the functions 311 and 312 is stored on the memory 140, and the temperature determining unit 421 obtains the data concerning the functions 311 and 312 by reading out the data from the memory 140. The temperature determining unit 421 outputs setting-value data to the wavelength determining unit 422, the setting-value data being created by associating data concerning each determined setting-value for the temperature control current with the working wavelength data, respectively.

The wavelength determining unit 422 changes the wavelength control current via the control unit 150, and respectively for each working wavelength, determines the setting-values of the wavelength control current such that a wavelength indicated by data output from the optical monitor 410 becomes the working wavelength (λ1 to λn). The wavelength determining unit 422 correlates data concerning each determined setting-value of the wavelength control current with the setting-value data output from the temperature determining unit 421, and outputs the correlated data to the bias determining unit 423.

The bias determining unit 423 changes the EA bias via the control unit 150, and for each working wavelength, determines the setting-value of the EA bias causing a transmission characteristic indicated by data output from the optical monitor 410 to become a desired transmission characteristic (optimum extinction ratio). The bias determining unit 423 correlates data concerning each determined setting-value of the EA bias with the setting-value data output from the wavelength determining unit 422, and outputs the correlated data to the memory 140.

The setting-value data output from the bias determining unit 423 to the memory 140 includes data concerning each respective setting-value for the temperature control current, the wavelength control current, and the EA bias, respectively corresponding to each working wavelength. The setting-value data is thus provided in the form of, for example, the table 200 of FIG. 2. The memory 140 stores the setting-value data output from the bias determining unit 423 as the above data concerning combinations of the setting-values.

While the optical transmitting apparatus 100 described herein includes the optical monitor 410, and determines data concerning combinations of each setting-value based on a result of monitoring light by the optical monitor 410, the optical transmitting apparatus 100 may include an obtaining unit in place of the optical monitor 410, where the obtaining unit obtains data concerning the wavelength and transmission characteristic of light received from a receiving device that receives light transmitted from the optical transmitting apparatus 100.

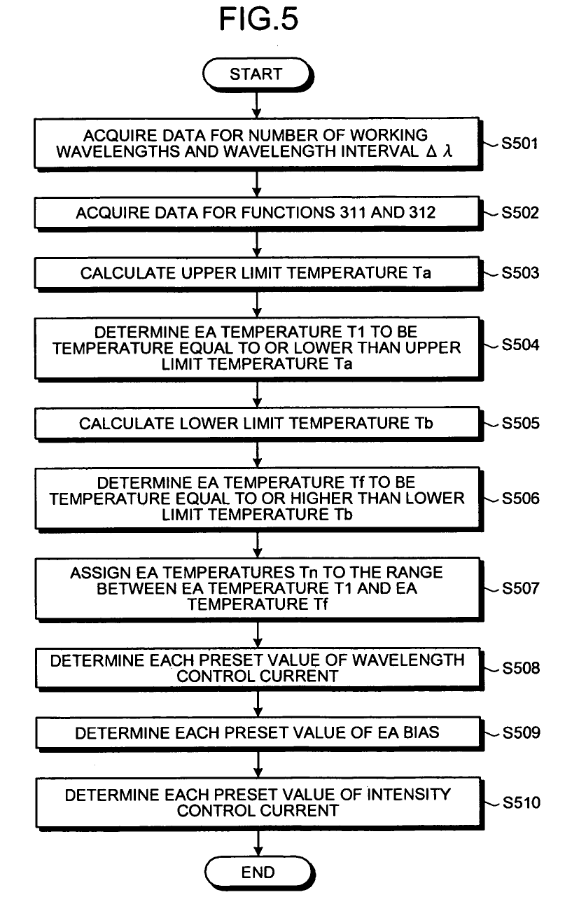

FIG. 5 is a flowchart of an example of a procedure of determining each setting-value. As shown in FIG. 5, the temperature determining unit 421 obtains data concerning the number of working wavelengths f and a wavelength interval αλ from input working wavelength data (step S501). The temperature determining unit 421 then obtains data concerning the functions 311 and 312 (see FIG. 3) (step S502).

Subsequently, based on the function 311 obtained at step S502, the temperature determining unit 421 calculates the EA temperature (45° C.) at which the FIT number becomes 5700 (desired value) as the upper limit temperature Ta of the EA temperature (step S503). The temperature determining unit 421 then determines an EA temperature T1 corresponding to the longest wavelength λ1 among working wavelengths to be a temperature equal to or lower than the upper limit temperature Ta calculated at step S503 (step S504). For example, the EA temperature T1 corresponding to the wavelength λ1 is determined to be the upper limit temperature Ta.

Subsequently, based on the function 312 obtained at step S502, the temperature determining unit 421 calculates the EA temperature (42° C.) at which power consumption becomes 1.4 W (desired value) as the lower limit temperature Tb of the EA temperature (step S505). The temperature determining unit 421 then determines an EA temperature Tf corresponding to the shortest wavelength λf among the working wavelengths to be a temperature equal to or higher than the lower limit temperature Tb calculated at step S505 (step S506). For example, the EA temperature Tf corresponding to the wavelength λf is determined to be the lower limit temperature Tb.

Subsequently, the temperature determining unit 421 assigns EA temperatures Tn (n=2, 3, . . . , f−1) corresponding to the wavelengths (λ2 to λf−1) among the working wavelengths, excluding the wavelengths λ1 and λf, to the range between the EA temperature T1 determined at step S504 and the EA temperature Tf determined at step S506 (step S507). For example, an EA temperature T(n) corresponding to any one of the wavelengths (λ2 to λf−1) is given by the equation below.

T(n)=T(n−1)+(Tf−T1)/(f−1) (1)

Then, the wavelength determining unit 422 determines each setting-value of the wavelength control current corresponding to each working wavelength, based on each setting-value of the EA temperature determined at steps S501 to S507 (step S508). For example, when the setting-value of the wavelength control current corresponding to the wavelength λ1 is determined, the value of the temperature control current input to the TEC 130 is adjusted via the control unit 150 to the setting-value corresponding to the wavelength λ1.

The wavelength control current input to the wavelength-variable light source 110 is changed via the control unit 105, and the value of the wavelength control current that causes a wavelength indicated by data output from the optical monitor 410 to become λ1 is determined to be the setting-value corresponding to the wavelength λ1. Each setting-value of the wavelength control current corresponding to each of the wavelengths λ2 to λn is determined in the same manner.

Then, the bias determining unit 423 determines each setting-value of the EA bias corresponding to each working wavelength, based on each setting-value of the EA temperature and that of the wavelength control current that are determined at steps S501 to S508 (step S509). For example, when the setting-value of the EA bias corresponding to the wavelength λ1 is determined, the value of the temperature control current and that of the wavelength control current are each adjusted via the control unit 150 to a setting-value corresponding to the wavelength λ1.

The EA bias input to the EA modulator 120 is changed via the control unit 105, and the value of the EA bias that causes a transmission characteristic indicated by data output from the optical monitor 410 to become a desired transmission characteristic (optimum extinction ratio) is determined to be the setting-value corresponding to the wavelength λ1. Each setting-value of the EA bias corresponding to each of the wavelengths λ2 to λn is determined in the same manner.

Data concerning combinations of the setting-values of the EA temperature determined at steps S501 to S507, the setting-values of the wavelength control current determined at step S508, and the setting-values of the EA bias determined at step S509 is respectively correlated with the working wavelengths and stored on the memory 140 (step S510), thereby ending a series of processing.

Based on the respective setting-values for the EA temperature, the wavelength control current, and the EA bias determined respectively for each working wavelength at steps S501 to S510, a function of the wavelength control current with respect to wavelength, a function of the EA temperature with respect to wavelength, and a function of the EA bias with respect to wavelength may be calculated approximately. In this case, the calculated functions are stored on the memory 140, ending a series of processing.

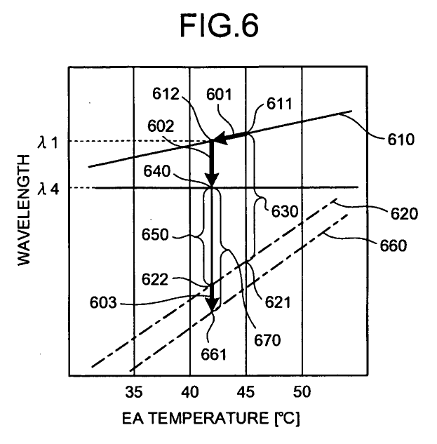

FIG. 6 is a graph concerning wavelength control, control of the EA temperature and the EA bandgap wavelength variation. In FIG. 6, the horizontal axis represents the temperature (° C.), and the vertical axis represents the wavelength. A line 610 indicates the variation of the output wavelength with respect to the EA temperature when the value of the wavelength control current is adjusted to the setting-value corresponding to the wavelength λ1. A point 611 indicates the output wavelength that results on the line 610 when the value of the temperature control current is adjusted to the setting-value (45° C.) corresponding to the wavelength λ1.

A line 620 indicates the variation of the EA bandgap wavelength with respect to the EA temperature when the value of the EA bias is adjusted to the setting-value corresponding to the wavelength λ1. A point 621 indicates the EA bandgap wavelength that results on the line 620 when the value of the temperature control current is adjusted to a setting-value for 45° C. A point 622 indicates the EA bandgap wavelength that results on the line 620 when the value of the temperature control current is adjusted to a setting-value for 42° C.

A wavelength shift 630 indicates a wavelength shift between the output wavelength (point 611) and the EA bandgap wavelength (point 621) in the initial state. This wavelength shift 630 in the initial state is assumed to be the adjusted wavelength shift that causes the transmission characteristic of light output from the EA modulator 120 to become a desired transmission characteristic (optimum extinction ratio).

First, by adjusting the value of the temperature control current to a setting-value corresponding to the wavelength λ4, as denoted by reference numeral 601, the EA temperature is controlled to become 42° C. (point 612). Then, by adjusting the value of the wavelength control current to a setting-value corresponding to the wavelength λ4, as denoted by reference numeral 602, the output wavelength is controlled to become λ4 (point 640).

A wavelength shift 650 indicates a wavelength shift between the output wavelength (point 640) and the EA bandgap wavelength (point 622) when the EA temperature control denoted by reference numeral 601 and the output wavelength control denoted by reference numeral 602 are performed. The wavelength shift 650 is smaller than the wavelength shift 630 in the initial state.

Then, by adjusting the value of the EA bias to a setting-value corresponding to the wavelength λ4, as denoted by reference numeral 603, the variation of the EA bandgap wavelength is controlled to change from that indicated by the line 620 to that indicated by a line 660. A point 661 indicates the EA bandgap wavelength that results on the line 660 when the EA temperature is 42° C.

A wavelength shift 670 indicates a wavelength shift between the output wavelength (point 640) and the EA bandgap wavelength (point 661) resulting when the control of the EA bandgap wavelength variation denoted by reference numeral 603 is performed. The wavelength shift 670 is substantially equivalent to the wavelength shift 630 in the initial state. Thus, the output wavelength can be varied from λ1 to λ4 without deteriorating the transmission characteristic of light transmitted from the optical transmitting apparatus 100.

In this manner, as a wavelength indicated by wavelength data increases, the control unit 150 performs control to adjust the temperature control current to raise the EA temperature, lower the value of the wavelength control current so that the output wavelength increases, and raise the value of the EA bias so that the EA bandgap wavelength variation rises. On the contrary, as a wavelength indicated by the wavelength data decreases, the control unit 150 performs control to adjust the temperature control current to lower the EA temperature, raise the value of the wavelength control current so that the output wavelength decreases, and lower the value of the EA bias so that the EA bandgap wavelength variation lowers.

Above, description is made of a case where respective values are set in the order of the EA temperature, the output wavelength, and the EA bias. However, combinations of the wavelength control current, the temperature control current, and the EA bias may be stored on the memory 140, and the EA temperature, the output wavelength, and the EA bias may be set concurrently based on data concerning the combinations.

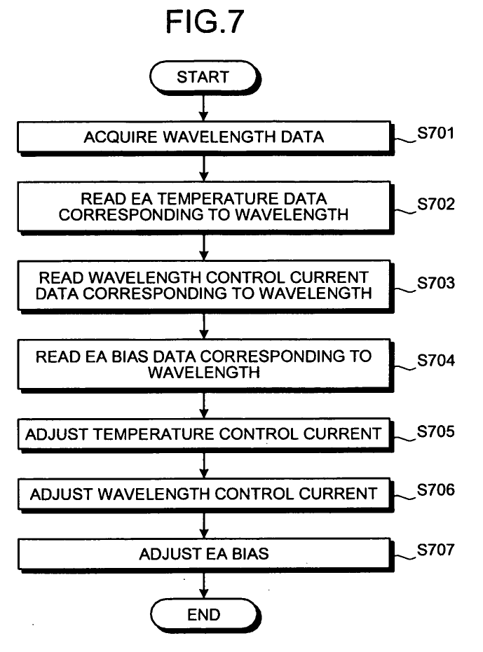

FIG. 7 is a flowchart of an example of control by the control unit. Here, description is made of a case where the control unit 150 adjusts each value based on data concerning combinations of each setting-value stored on the memory 140. As shown in FIG. 7, wavelength data is obtained from an external source (step S701). Data concerning the setting-value of the EA temperature corresponding to a wavelength indicated by the wavelength data obtained at step S701 is read out from the memory 140 (step S702).

Data concerning the setting-value of the wavelength control current corresponding to the wavelength indicated by the wavelength data is read out from the memory 140 (step S703). Data concerning the setting-value of the EA bias corresponding to the wavelength indicated by the wavelength data is read out from the memory 140 (step S704).

Based on the data read out at step S702, the temperature control current input to the TEC 130 is adjusted (step S705). Based on the data read out at step S703, the wavelength control current input to the wavelength-variable light source 101 is then adjusted (step S706). Based on the data read out at step S704, the EA bias input to the EA modulator 120 is then adjusted (step S707), thereby ending a series of processing.

Above, description is made of control that is performed by consecutively reading out from the memory 104 the setting-values for the temperature control current, the wavelength control current, and the EA bias, respectively and then adjusting each value, respectively. The control, however, may be performed by adjusting the value of the temperature control current, the wavelength control current, and the EA bias one by one at each read out.

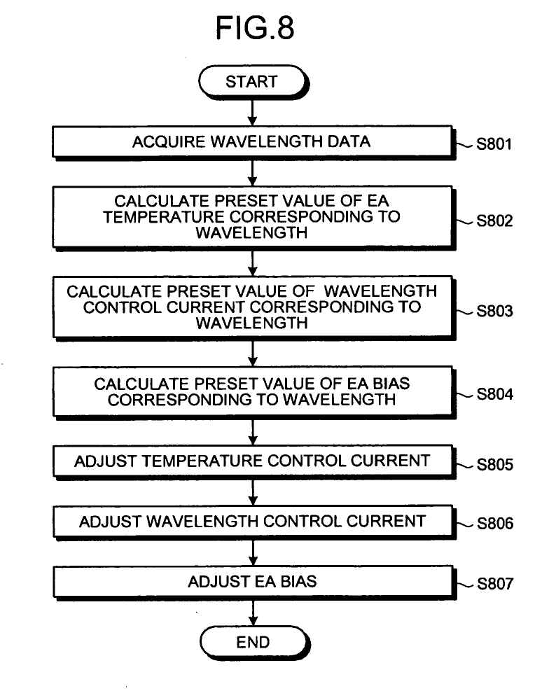

FIG. 8 is a flowchart of another example of control by the control unit. Here, description is made of a case where the control unit 150 adjusts each value based on functions of setting-values stored on the memory 140. As shown in FIG. 8, wavelength data is obtained from an external source (step S801). A function of the EA temperature with respect to wavelength is read out from the memory 140, and the setting-value of the EA temperature corresponding to a wavelength indicated by the wavelength data obtained at step S801 is calculated based on the read function (step S802).

A function of the wavelength control current with respect to wavelength is read out from the memory 140, and the setting-value of the wavelength control current corresponding to the wavelength indicated by the wavelength data is calculated based on the read function (step S803). A function of the EA bias with respect to wavelength is read out from the memory 140, and the setting-value of the EA bias corresponding to the wavelength indicated by the wavelength data is calculated based on the read function (step S804).

Based on the setting-value calculated at step S802, the temperature control current input to the TEC 130 is adjusted (step S805). Based on the setting-value calculated at step S803, the wavelength control current input to the wavelength-variable light source 101 is then adjusted (step S806). Based on the setting-value calculated at step S804, the EA bias input to the EA modulator 120 is then adjusted (step S807), thereby ending a series of processing.

Above, description is made of control that is performed by consecutively calculating the setting-values for the temperature control current, the wavelength control current, and the EA bias, respectively and then adjusting each value, respectively. The control, however, may be performed by adjusting the value of the temperature control current, the wavelength control current, and the EA bias one by one at each calculation.

As described above, according to the optical transmitting apparatus 100 of the first embodiment, the value of the wavelength control current input to the wavelength-variable light source 110 is adjusted in correspondence to a wavelength, and the value of the EA bias input to the EA modulator 120 and the value of the temperature control current input to the TEC 130 are also each adjusted in correspondence to a wavelength, thereby enabling, at the time of wavelength control, an improvement in a transmission characteristic.

In addition, at the time of wavelength control, by performing EA temperature control and EA bias control, the EA temperature control range 330 necessary for securing a transmission characteristic can be reduced, thereby enabling a reduction in power consumption by the optical transmitting apparatus 100. As a result, the optical transmitting apparatus 100 provides satisfactory power consumption and reliability required for application to a TOSA, thereby facilitating application of the optical transmitting apparatus 100 to the TOSA.

According to the above description of the first embodiment, the control unit 150 adjusts the values for the wavelength control current, the EA bias, and the temperature control current in correspondence to a wavelength. The control unit 150, however, may adjust the value of the wavelength control current and that of the EA bias in correspondence to a wavelength, and adjust the value of the temperature control current to a constant value independent of wavelength. Further, the control unit 150 may adjust the value of the wavelength control current and that of the temperature control current in correspondence to a wavelength, and adjust the value of the EA bias to a constant value independent of wavelength.

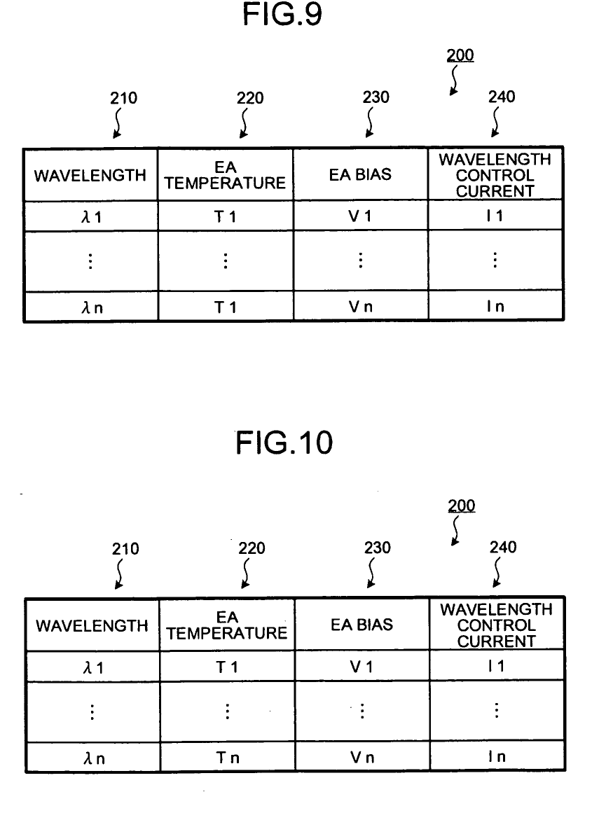

FIG. 9 depicts a second example of data stored on the memory. In FIG. 9, similar portions described in FIG. 2 are denoted by similar reference numerals, and description thereof is omitted. FIG. 9 depicts the table 200 that results when the control unit 150 adjusts the value of the wavelength control current input to the wavelength-variable light source 110 and that of the EA bias input to the EA modulator 120 in correspondence to a wavelength, and adjusts the value of the temperature control current input to the TEC 130 to a constant value.

As denoted by reference numeral 220, all of the setting-values for the EA temperatures that correspond to the wavelengths λ1 to λn, respectively are T1. In this case, data concerning combinations of setting-values stored in the form of the table 200 is determined by determining the respective setting-values in the order of the wavelength control current and the EA bias (see FIG. 19). The EA temperature data may not be stored on the table 200, and data indicating that all setting-values of the EA temperature are T1 may be stored on the memory 140 separately from the table 200.

FIG. 10 depicts a third example of data stored on the memory. In FIG. 10, similar portions described in FIG. 2 are denoted by the similar reference numerals, and description thereof is omitted. FIG. 10 depicts the table 200 that results when the control unit 150 adjusts the value of the wavelength control current input to the wavelength-variable light source 110 and that of the temperature control current input to the TEC 130 in correspondence to a wavelength, and adjusts the value of the EA bias input to the EA modulator 120 to a constant value.

In this case, as denoted by reference numeral 230, all of the setting-values of EA biases that correspond to the wavelengths λ1 to λ1, respectively are V1. In this case, data concerning combinations of setting-values stored in the form of the table 200 is determined by determining the respective setting-values in the order of the temperature control current and the wavelength control current (see FIG. 21). The EA bias data may not be stored on the table 200, and data indicating that all setting-values of the EA bias are V1 may be stored on the memory 140 separately from the table 200.

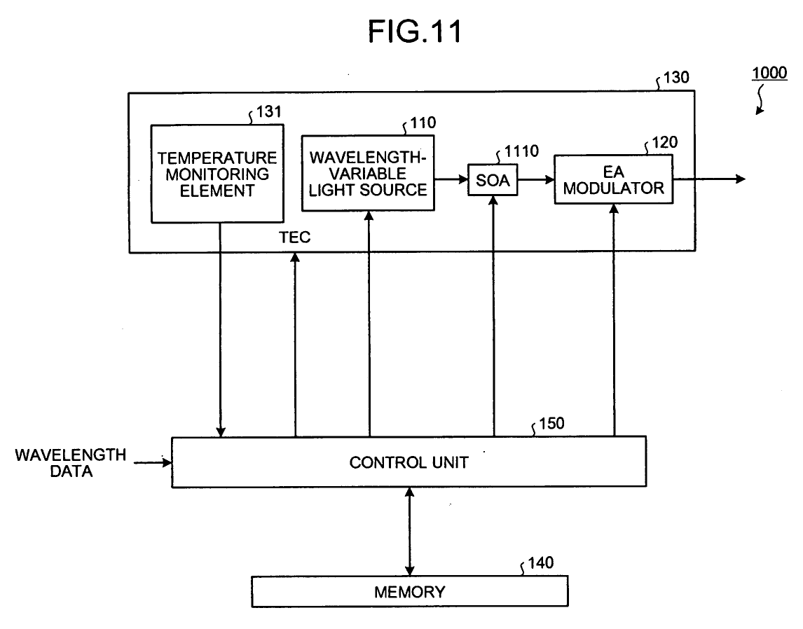

FIG. 11 is a block diagram of a functional configuration of an optical transmitting apparatus according to the second embodiment. In FIG. 11, similar constituent elements shown in FIG. 1 are denoted by similar reference numerals and description thereof is omitted. As shown in FIG. 11, an optical transmitting apparatus 1000 of the second embodiment includes a semiconductor optical amplifier (SOA) 1110, in addition to the constituent elements of the optical transmitting apparatus 100 of the first embodiment.

The SOA 1110 is mounted together with the wavelength-variable light source 110 and the EA modulator 120 in an integral configuration on the TEC 130. The wavelength-variable light source 110 outputs generated light to the SOA 1110, which receives the light output from the wavelength-variable light source 110 and an intensity control current that is output from the control unit 150. The SOA 1110 amplifies light output from the wavelength-variable light source 110 in correspondence to the input intensity control current from the control unit 150.

The SOA 1110 outputs amplified light to the EA modulator 120, which receives the light output from the SOA 1110 and an EA bias output from the control unit 150. The EA modulator 120 modulates the light output from the SOA 1110. The memory 140 stores data concerning combinations of the respective setting-values for the wavelength control current, the EA bias, the temperature control current, and the intensity control current, the data corresponding to the working wavelengths, respectively.

The control unit 150 inputs the intensity control current to the SOA 1110, and controls the intensity of light output from the SOA 1110 by adjusting the intensity control current input to the SOA 1110. The control unit 150 adjusts, in correspondence to a wavelength, a combination of the respective values for the wavelength control current input to the wavelength-variable light source 110, the EA bias input to the EA modulator 120, the temperature control current input to the TEC 130, and the intensity control current input to the SOA 1110.

Specifically, the control unit 150 reads out a piece of combination data that corresponds to a wavelength indicated by input wavelength data, from the combination data stored on the memory 140. Based on the combination data read out from the memory 140, the control unit 150 adjusts the value of the wavelength control current input to the wavelength-variable light source 110, the value of the EA bias input to the EA modulator 120, the value of the temperature control current input to the TEC 130, and the value of the intensity control current input to the SOA 1110.

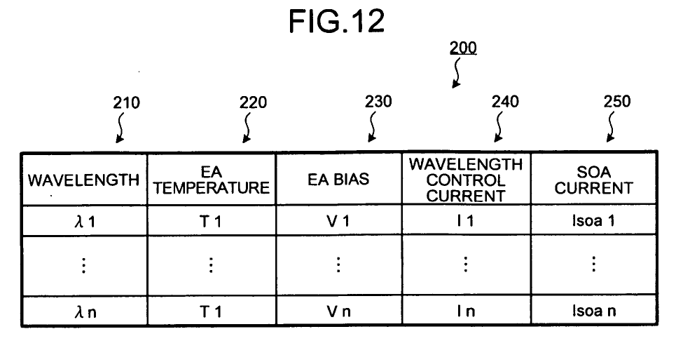

FIG. 12 depicts a fourth example of data stored on the memory. In FIG. 12, similar portions described in FIG. 2 are denoted by similar reference numerals, and description thereof is omitted. FIG. 12 depicts the table 200 that results when the control unit 150 adjusts the wavelength control current input to the wavelength-variable light source 110, the EA bias input to the EA modulator 120, the temperature control current input to the TEC 130, and the intensity control current input to the SOA 1110 in correspondence to a wavelength.

As shown in FIG. 12, the table 200 stored on the memory 140 of the optical transmitting apparatus 1000 includes data concerning intensity control currents (Tsoa 1 to Tsoa n) corresponding to working wavelengths (λ1 to λn), in addition to the data included in the table 200 of FIG. 2. The control unit 150 inputs, to the SOA 1110, the intensity control current corresponding to a wavelength indicated by wavelength data.

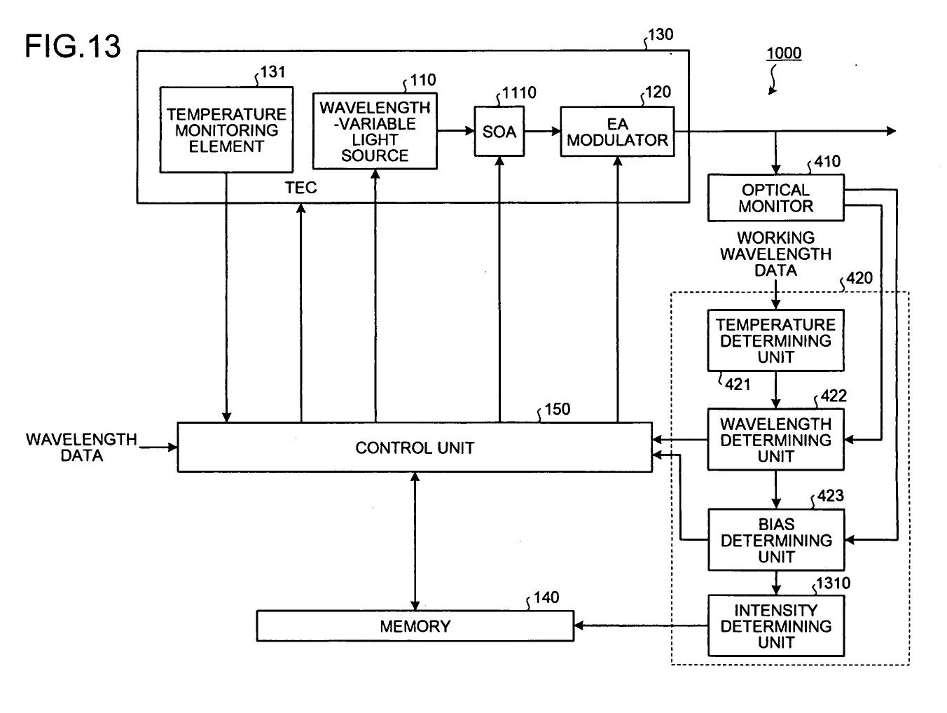

FIG. 13 is a block diagram of a modification example of the functional configuration of the optical transmitting apparatus. In FIG. 13, similar constituent elements shown in FIGS. 4 and 11 are denoted by similar reference numerals, and description thereof is omitted. As shown in FIG. 13, the optical transmitting apparatus 1000 may include the optical monitor 410, and the setting-value determining unit 420, in addition to the constituent elements shown in FIG. 11. The optical monitor 410 monitors the wavelength and transmission characteristic of the light and further monitors the intensity of the light. The optical monitor 410 outputs data concerning the monitored intensity to the setting-value determining unit 420.

The setting-value determining unit 420 determines data concerning combinations of each setting-value stored on the memory 140 by determining the respective setting-values in the order of the temperature control current, the wavelength control current, the EA bias, and the intensity control current, respectively, for each of working wavelengths (λ1 to λn) of the optical transmitting apparatus 1000. Specifically, the setting-value determining unit 420 includes the temperature determining unit 421, the wavelength determining unit 422, the bias determining unit 423, and an intensity determining unit 1310.

The bias determining unit 423 outputs setting-value data with which data concerning each determined setting-value of the EA bias is correlated, to the intensity determining unit 1310. The intensity determining unit 1310 changes the intensity control current via the control unit 150, and determines the values of the intensity control currents that cause an intensity indicated by the data output from the optical monitor 410 to become a desired intensity to be the setting-values of the intensity control currents corresponding to the working wavelengths, respectively. The intensity determining unit 1310 correlates data concerning each determined setting-value of the intensity control current with the setting-value data output from the bias determining unit 423, and outputs the correlated data to the memory 140.

The setting-value data output from the intensity determining unit 1310 to the memory 140 includes data concerning the setting-values of the temperature control current, that of the wavelength control current, that of the EA bias, and that of the intensity control current corresponding to the working wavelengths, respectively. The setting-value data is thus provided in the form of, for example, the table 200 of FIG. 12. The memory 140 stores the setting-value data output from the intensity determining unit 1310 as the above data concerning combinations of each setting-value.

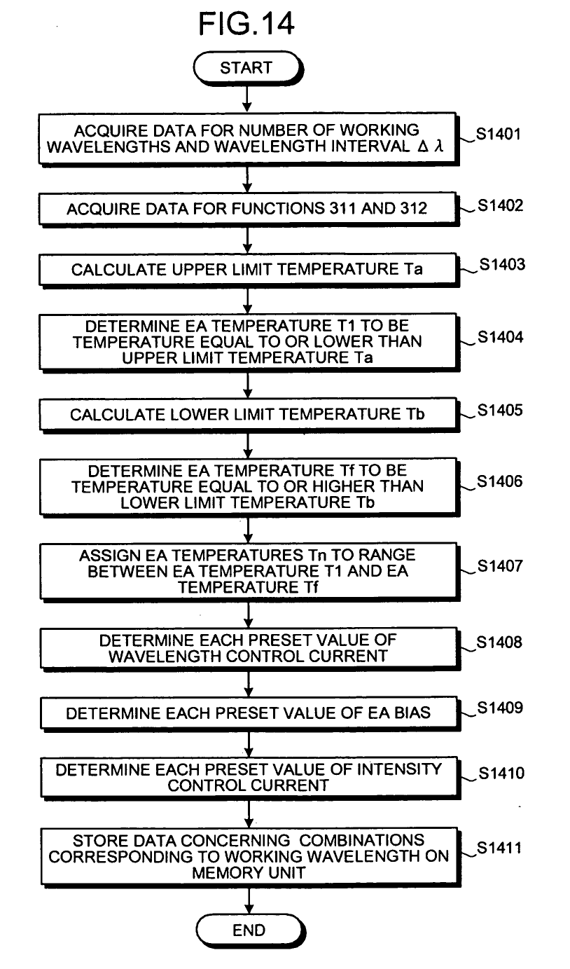

FIG. 14 is a flowchart of an example of a procedure of determining each setting-value. In FIG. 14, steps S1401 to S1409 are the same as steps S501 to S509 shown in FIG. 5 and description thereof is omitted. As shown in FIG. 14, after the setting-values of the EA bias corresponding to the working wavelengths, respectively, are determined at step S1409, the intensity determining unit 1310 determines the setting-values of the intensity control current corresponding to the working wavelengths, respectively (step S1410).

For example, when the setting-value of the intensity control current corresponding to the wavelength λ1 is determined, the value of the temperature control current, that of the wavelength control current, and that of the EA bias are each adjusted via the control unit 150 to setting-values corresponding to the wavelength λ1. Then, the wavelength control current input to the wavelength-variable light source 110 is changed via the control unit 150, and the value of the intensity control current that causes an intensity indicated by data output from the optical monitor 410 to become a desired intensity is determined to be the setting-value corresponding to the wavelength λ1. The setting-values of intensity control currents corresponding to the wavelengths λ2 to λn are determined in the same manner.

Then, data concerning combinations of each setting-value of the EA temperature determined at steps S1403 to S1407, each setting-value of the wavelength control current determined at step S1408, each setting-value of the EA bias determined at step S1409, and each setting-value of the intensity control current determined at step S1410 is correlated to the working wavelength, respectively and stored on the memory 140 (step S1411), thereby ending a series processing.

As described above, the optical transmitting apparatus 1000 according to the second embodiment provides the same effect as that of the optical transmitting apparatus 100 according to the first embodiment, and controls a gain in the light by the SOA 1110, using the setting-value of the intensity control current that is determined after determining each of the respective setting-values for the temperature control current, the wavelength control current, and the EA bias. The optical transmitting apparatus 1000, therefore, can perform control by adjusting, at the time of wavelength control, the intensity of the light to be transmitted to a desired intensity without deterioration of a transmission characteristic.

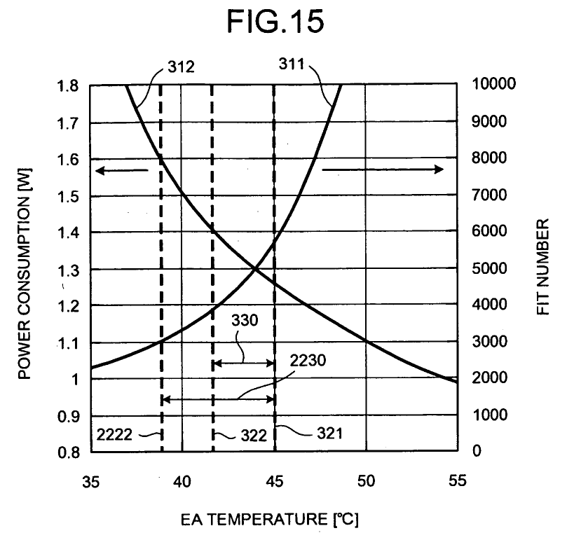

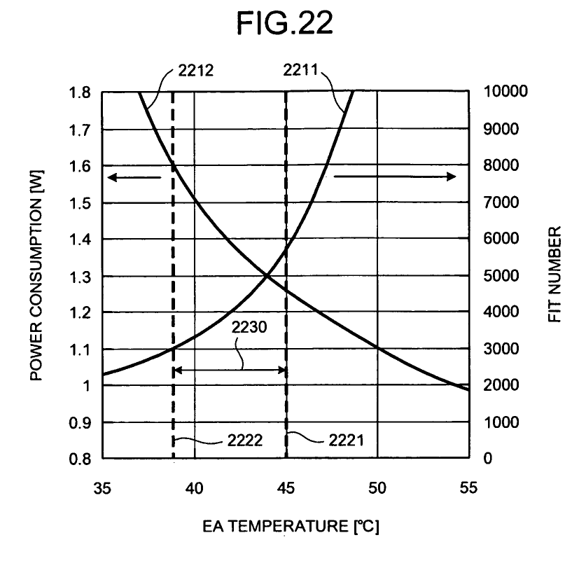

FIG. 15 is a graph of the relation between the FIT number, power consumption, and the EA temperature. In FIG. 15, similar portions described in FIG. 3 are denoted by similar reference numerals and description thereof is omitted. A range 2230 indicates an EA temperature control range (see FIG. 22) that a conventional optical transmitting apparatus must secure to provide a satisfactory transmission characteristic. In contrast, the optical transmitting apparatus 1000 can reduce the EA temperature control range 330 thereof by additionally performing EA temperature control and EA bias control.

This enables a reduction in power consumption by the optical transmitting apparatus 1000. In this case, the power consumption becomes 1.4 W, which satisfies a range of power consumption that is required when the optical transmitting apparatus is applied to a TOSA. Thus, the optical transmitting apparatus 1000 provides satisfactory power consumption and reliability required for application to a TOSA, thereby facilitating application to the TOSA.

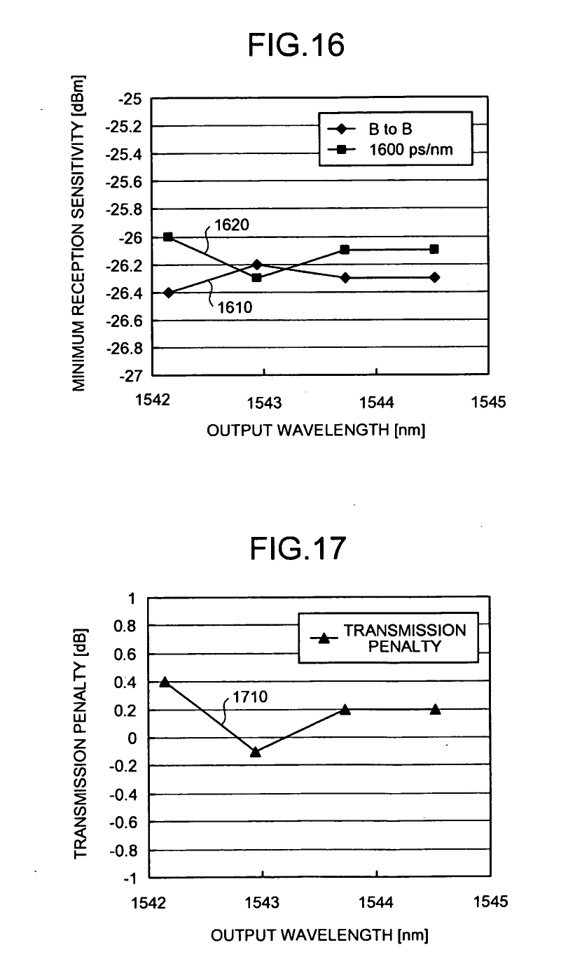

FIG. 16 is a graph of the relation between the minimum reception sensitivity and the output wavelength. In FIG. 16, the horizontal axis represents the output wavelength (nm) from the optical transmitting apparatus 100, 1000, and the vertical axis represents the minimum reception sensitivity (dBm) of light transmitted from the optical transmitting apparatus 100, 1000. Reference numerals 1610 and 1620 indicate the minimum reception sensitivities of light transmitted from the optical transmitting apparatus 100, 1000 that result when the optical transmitting apparatus 100, 1000 varies the output wavelength from λ1 to λ4.

Reference numeral 1610 indicates the minimum reception sensitivity of light (with no wavelength dispersion) immediately after transmission from the optical transmitting apparatus 100, 1000. Reference numeral 1620 indicates the minimum reception sensitivity of light transmitted after passing through a transmission path (approximately 80 km) in which a wavelength dispersion of 1600 ps/nm occurs. As denoted by reference numerals 1610 and 1620, the minimum reception sensitivity of light from the optical transmitting apparatus 100, 1000 minimally deteriorates even when the output wavelength from the optical transmitting apparatus 1000 is changed to 1542 (nm), to 1543 (nm), to 1544 (nm), and to 1545 (nm).

FIG. 17 is a graph of the relation between the transmission penalty and the output wavelength. In FIG. 17, the horizontal axis represents the output wavelength (nm) from the optical transmitting apparatus 100, 1000. Reference numeral 1710 indicates the transmission penalty (dB) of the optical transmitting apparatus 100, 1000. As shown in FIG. 17, the transmission penalty (dB) of the optical transmitting apparatus 100, 1000 minimally deteriorates even when the output wavelength from the optical transmitting apparatus 100 is changed to 1542 (nm), to 1543 (nm), to 1544 (nm), and to 1545 (nm).

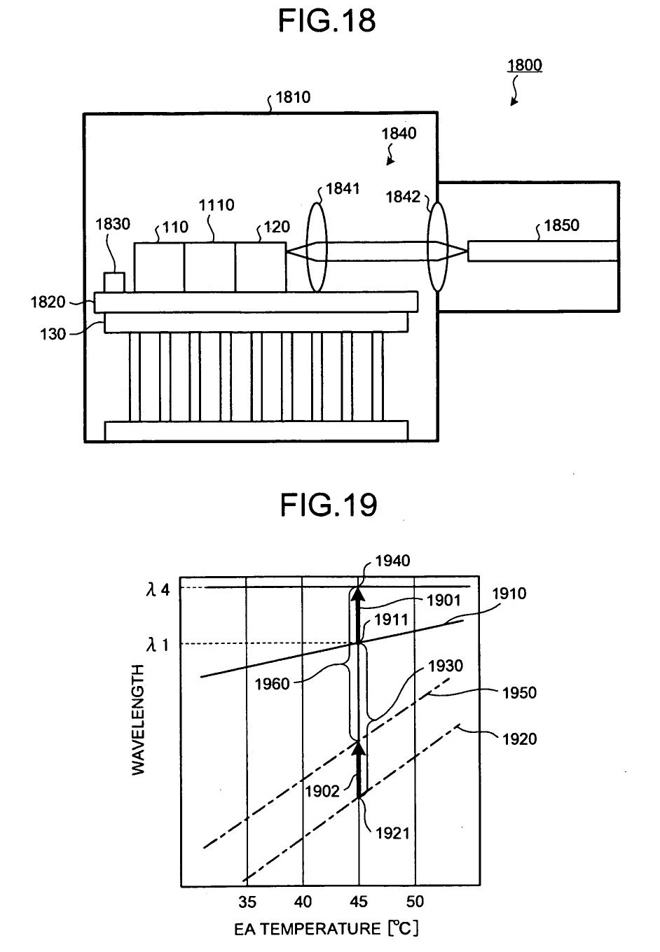

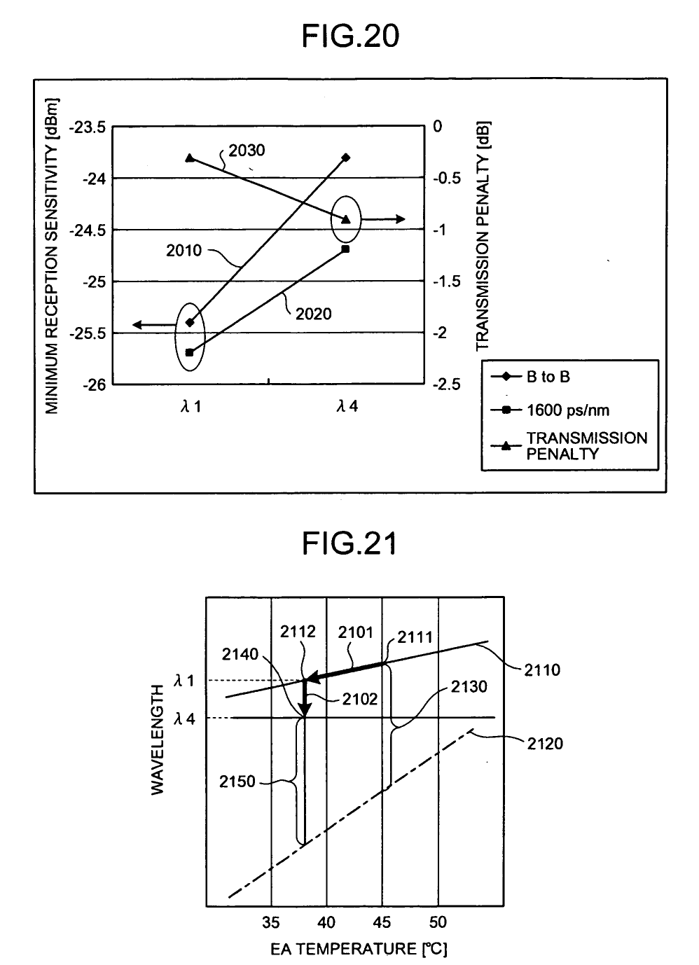

FIG. 18 is a front sectional view of an application example of the optical transmitting apparatus to a TOSA. In FIG. 18, similar constituent elements described in FIG. 11 are denoted by similar reference numerals and description thereof is omitted. A TOSA 1800 shown in FIG. 18 is an example of application of the above optical transmitting apparatus 1000 to the TOSA. The TOSA 1800 includes an enclosure 1810, a substrate 1820, the wavelength-variable light source 110, the SOA 1110, the EA modulator 120, a thermistor 1830, an optical system 1840, an optical fiber 1850, and the TEC 130.

The substrate 1820 is disposed on the TEC 130. On the substrate 1820, the wavelength-variable light source 110, the SOA 1110, the EA modulator 120, and the thermistor 1830 are mounted in an integrated configuration. The control unit 150, temperature determining unit 421, wavelength determining unit 422, bias determining unit 423, and intensity determining unit 1310, for example, are included in a central processing unit (CPU) (not shown), which is disposed on the substrate 1820.

The memory 140 (not shown) is also disposed on the substrate 1820, and is connected to the control unit 150 via the substrate 1820. The control unit 150 inputs the wavelength control current, the EA bias, the temperature control current, and the intensity control current to the wavelength-variable light source 110, the EA modulator 120, the TEC 130, and the SOA 1110, respectively, via the substrate 1820. The thermistor 1830 is equivalent to the temperature monitoring element 131, and outputs a current corresponding to the temperature of the substrate 1820 as EA temperature data to the control unit 150.

The optical system 1840 has a collimator lens 1841 that collimates light emitted from the EA modulator 120, and a condenser lens 1842 that condenses light collimated by the collimator lens 1841 onto the optical fiber 1850, which outputs light condensed by the condenser lens 1842 to an external unit.

As described above, the optical transmitting apparatus and the setting-value determining method according to the embodiments improve a transmission characteristic at the time of wavelength control.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An optical transmitting apparatus comprising:
a light source that generates light having a wavelength according to a wavelength control current input to the light source;
a modulator that modulates the light based on a modulation characteristic corresponding to an EA bias input to the modulator;
a temperature adjusting unit that changes an EA temperature of the modulator according to a temperature control current input to the temperature adjusting unit; and
a control unit that controls the wavelength of the light and the modulation characteristic by adjusting a value of the wavelength control current and a value of the EA bias according to input wavelength data.

2. The optical transmitting apparatus according to claim 1, wherein
the control unit controls the EA temperature, the wavelength of light, and the modulation characteristic by adjusting, according to a wavelength indicated by the input wavelength data, a value of the EA temperature controlled by adjustment of the temperature control current; the value of the wavelength control current input to the light source; and the value of the EA bias.

3. The optical transmitting apparatus according to claim 1, wherein
the control unit performs control to raise the value of the EA temperature, lower the value of the wavelength control current, and raise the value of the EA bias as the wavelength indicated by the wavelength data increases.

4. The optical transmitting apparatus according to claim 1, wherein
the temperature adjusting unit is a thermoelectric cooler, and
the light source and the modulator are mounted in an integrated configuration on the thermoelectric cooler.

5. The optical transmitting apparatus according to claim 4, wherein
the thermoelectric cooler is equipped with a temperature monitoring element that outputs data indicating a temperature of the thermoelectric cooler, and
the control unit adjusts the temperature control current input in correspondence to the data output from the temperature monitoring element.

6. The optical transmitting apparatus according to claim 1, further comprising a memory unit that stores combination data concerning a combination of a setting-value of the EA temperature, a setting-value of the wavelength control current, and a setting-value of the EA bias and corresponding to a working wavelength that corresponds to a wavelength indicated by the input data, wherein
the control unit adjusts the value of the EA temperature, the value of the wavelength control current, and the value of the EA bias based on the combination data.

7. The optical transmitting apparatus according to claim 1, further comprising a memory unit that stores a function of the EA temperature with respect to wavelength, a function of the wavelength control current with respect to wavelength, and a function of the EA bias with respect to wavelength, wherein
the control unit calculates a setting-value of the wavelength control current, a setting-value of the EA temperature, and a setting-value of the EA bias, based on the function of the EA temperature with respect to wavelength, the function of the wavelength control current with respect to wavelength, the function of the EA bias with respect to wavelength and a wavelength indicated by the wavelength data, and performs value adjustment based on the setting-value of the wavelength control current, the setting-value of the EA temperature and the setting-value of the EA bias calculated, respectively.

8. The optical transmitting apparatus according to claim 6, further comprising:
a temperature determining unit that, based on data concerning a reliability parameter and power consumption of the optical transmitting apparatus, determines the setting-value of the EA temperature corresponding to the working wavelength;
a wavelength determining unit that, based on the setting-value determined by the temperature determining unit, determines the setting-value of the wavelength control current corresponding to the working wavelength; and
a bias determining unit that, based on the setting-value determined by the temperature determining unit and the setting-value determined by the wavelength determining unit, determines the setting-value of the EA bias corresponding to the working wavelength, wherein
the combination data concerns a combination of the setting-value determined by the temperature determining unit, the setting-value determined by the wavelength determining unit, and the setting-value determined by the bias determining unit.

9. The optical transmitting apparatus according to claim 1, further comprising an optical amplifier that amplifies the light output from the light source to the modulator according to an intensity control current input to the optical amplifier, wherein
the control unit adjusts the value of the EA temperature, the value of wavelength control current, the value of the EA bias, and a value of the intensity control current according to the input wavelength data.

10. The optical transmitting apparatus according to claim 9, further comprising a memory unit that stores combination data concerning a combination of a setting-value of the EA temperature, a setting-value of the wavelength control current, a setting-value of the EA bias, and a setting-value of the intensity control current, the combination data corresponding to a working wavelength that corresponds to a wavelength indicated by the input data, wherein
the control unit adjusts the value of the EA temperature, the value of the wavelength control current, and the value of the EA bias, and the value of the intensity control current, based on the combination data.

11. The optical transmitting apparatus according to claim 10 further comprising:
a temperature determining unit that, based on data concerning a reliability parameter and power consumption of the optical transmitting apparatus, determines the setting-value of the EA temperature corresponding to the working wavelength;
a wavelength determining unit that, based on the setting-value determined by the temperature determining unit, determines the setting-value of the wavelength control current corresponding to the working wavelength;
a bias determining unit that, based on the setting-value determined by the temperature determining unit and the setting-value determined by the wavelength determining unit, determines the setting-value of the EA bias corresponding to the working wavelength; and
an intensity determining unit that, based on the setting-value determined by the temperature determining unit, the setting-value determined by the wavelength determining unit, and the setting-value determined by the bias determining unit, determines the setting-value of the intensity control current corresponding to the working wavelength, wherein
the combination data concerns a combination of the setting-value determined by the temperature determining unit, the setting-value determined by the wavelength determining unit, the setting-value determined by the bias determining unit, and the setting-value determined by the intensity determining unit.

12. An optical transmitting apparatus comprising:
a light source that generates light having a wavelength according to a wavelength control current input to the light source;
a modulator that modulates the light based on a modulation characteristic corresponding to an EA bias input to the modulator;
a temperature adjusting unit that changes an EA temperature of the modulator according to a temperature control current input to the temperature adjusting unit; and
a control unit that controls the EA temperature and the wavelength of the light by adjusting a value of the EA temperature controlled by adjustment of the temperature control current and a value of the wavelength control current according to a wavelength indicated by input wavelength data.

13. The optical transmitting apparatus according to claim 12, wherein
the temperature adjusting unit is a thermoelectric cooler, and
the light source and the modulator are mounted in an integrated configuration on the thermoelectric cooler.

14. The optical transmitting apparatus according to claim 13, wherein
the thermoelectric cooler is equipped with a temperature monitoring element that outputs data indicating a temperature of the thermoelectric cooler, and
the control unit adjusts the temperature control current input in correspondence to the data output from the temperature monitoring element.

15. The optical transmitting apparatus according to claim 12, further comprising a memory unit that stores combination data concerning a combination of a setting-value of the EA temperature, a setting-value of the wavelength control current, and a setting-value of the EA bias and corresponding to a working wavelength that corresponds to the wavelength indicated by the input data, wherein
the control unit adjusts the value of the EA temperature, the value of the wavelength control current, and the value of the EA bias based on the combination data.

16. The optical transmitting apparatus according to claim 12, further comprising a memory unit that stores a function of the EA temperature with respect to wavelength, a function of the wavelength control current with respect to wavelength, and a function of the EA bias with respect to wavelength, wherein
the control unit calculates a setting-value of the wavelength control current, a setting-value of the EA temperature, and a setting-value of the EA bias, based on the function of the EA temperature with respect to wavelength, the function of the wavelength control current with respect to wavelength, the function of the EA bias with respect to wavelength and the wavelength indicated by the wavelength data, and performs value adjustment based on the setting-value of the wavelength control current, the setting-value of the EA temperature and the setting-value of the EA bias calculated, respectively.

17. The optical transmitting apparatus according to claim 15, further comprising:
a temperature determining unit that, based on data concerning a reliability parameter and power consumption of the optical transmitting apparatus, determines the setting-value of the EA temperature corresponding to the working wavelength;
a wavelength determining unit that, based on the setting-value determined by the temperature determining unit, determines the setting-value of the wavelength control current corresponding to the working wavelength; and
a bias determining unit that, based on the setting-value determined by the temperature determining unit and the setting-value determined by the wavelength determining unit, determines the setting-value of the EA bias corresponding to the working wavelength, wherein
the combination data concerns a combination of the setting-value determined by the temperature determining unit, the setting-value determined by the wavelength determining unit, and the setting-value determined by the bias determining unit.

18. The optical transmitting apparatus according to claim 12, further comprising an optical amplifier that amplifies the light output from the light source to the modulator according to an intensity control current input to the optical amplifier, wherein
the control unit adjusts the value of the EA temperature, the value of wavelength control current, the value of the EA bias, and a value of the intensity control current according to the input wavelength data.

19. The optical transmitting apparatus according to claim 18, further comprising a memory unit that stores combination data concerning a combination of a setting-value of the EA temperature, a setting-value of the wavelength control current, a setting-value of the EA bias, and a setting-value of the intensity control current, the combination data corresponding to a working wavelength that corresponds to the wavelength indicated by the input data, wherein
the control unit adjusts the value of the EA temperature, the value of the wavelength control current, and the value of the EA bias, and the value of the intensity control current, based on the combination data.

20. The optical transmitting apparatus according to claim 19 further comprising:
a temperature determining unit that, based on data concerning a reliability parameter and power consumption of the optical transmitting apparatus, determines the setting-value of the EA temperature corresponding to the working wavelength;
a wavelength determining unit that, based on the setting-value determined by the temperature determining unit, determines the setting-value of the wavelength control current corresponding to the working wavelength;
a bias determining unit that, based on the setting-value determined by the temperature determining unit and the setting-value determined by the wavelength determining unit, determines the setting-value of the EA bias corresponding to the working wavelength; and
an intensity determining unit that, based on the setting-value determined by the temperature determining unit, the setting-value determined by the wavelength determining unit, and the setting-value determined by the bias determining unit, determines the setting-value of the intensity control current corresponding to the working wavelength, wherein
the combination data concerns a combination of the setting-value determined by the temperature determining unit, the setting-value determined by the wavelength determining unit, the setting-value determined by the bias determining unit, and the setting-value determined by the intensity determining unit.

21. A setting-value determining method of an optical transmitting apparatus comprising:
determining a setting-value of an EA temperature corresponding to a working wavelength, based on data concerning a reliability parameter and power consumption of an optical transmitting apparatus;
determining a setting-value of a wavelength control current corresponding to the working wavelength, based on the setting-value of the EA temperature; and
determining a setting-value of an EA bias corresponding to the working wavelength, based on the setting-value of a temperature control current and the setting-value of the wavelength control current.

22. The setting-value determining method according to claim 21 further comprising storing data concerning a combination of the setting-value of the EA temperature, the setting-value of the wavelength control current, and the setting-value of the EA bias, the data corresponding to the working wavelength.

23. The setting-value determining method according to claim 21 further comprising approximating a function of the wavelength control current with respect to wavelength, a function of the EA temperature with respect to wavelength, and a function of the EA bias with respect to wavelength, based on the setting-value of the EA temperature, the setting-value of the wavelength control current, and the setting-value of the EA bias.

24. The setting-value determining method according to claim 21, wherein the determining the setting-value of the EA temperature includes
calculating an upper limit of the EA temperature at which a value of the reliability parameter becomes a desired value or larger, based on a function of the reliability parameter with respect to the EA temperature,
calculating a lower limit of the EA temperature at which a value of the power consumption becomes a desired value or smaller, based on a function of the power consumption with respect to the EA temperature, and
determining the setting-value of the EA temperature corresponding to the working wavelength within a range defined by the upper limit and the lower limit.

25. The setting-value determining method according to claim 21, wherein the determining the setting-value of the wavelength control current includes
setting the setting-value of the EA temperature corresponding to the working wavelength, and
determining a wavelength control current that causes a wavelength of light output from a modulator to become the working wavelength as the setting-value of the wavelength control current corresponding to the working wavelength.

26. The setting-value determining method according to claim 21, wherein the determining the setting-value of the EA bias includes
setting the setting-value of the EA temperature corresponding to the working wavelength and the setting-value of the wavelength control current corresponding to the working wavelength, and
determining an EA bias that causes a transmission characteristic of light output from a modulator to become a desired transmission characteristic as the setting-value of the EA bias corresponding to the working wavelength.

27. The setting-value determining method according to claim 21 further comprising determining a setting-value of an intensity control current corresponding to the working wavelength, based on the setting-value of the EA temperature, the setting-value of the wavelength control current, and the setting-value of the EA bias.

28. The setting-value determining method according to claim 27, wherein the determining the setting-value of the intensity control current includes
setting the setting-value of the EA temperature corresponding to the working wavelength, the setting-value of the wavelength control current corresponding to the working wavelength, and the setting-value of the EA bias corresponding to the working wavelength, and
determining an intensity control current that causes an intensity of light output from a modulator to become a desired intensity as the setting-value of the intensity control current corresponding to the working wavelength.
